(19) United States
(12) Patent Application Publication
(10) Pub. No.: US 2024/0289376 A1
(43) Pub. Date: Aug. 29, 2024

(54) SYSTEMS AND METHODS FOR ESTIMATING THE EFFECTIVENESS OF A CUMULATIVE CODING OF A COLLECTION OF RECORDS

(71) Applicant: Redgrave Strategic Data Solutions, LLC, Chantilly, VA (US)

(72) Inventors: DAVID DOLAN LEWIS, Lakewood, CO (US); LENORA DIANE GRAY, Reston, VA (US); JEREMY GARNER PICKENS, Delhi, NY (US); TARA SHAUN EMORY, Falls Church, VA (US); MARK NOEL, Pine, CO (US); ARAVIND KUCHIBHATLA, Frisco, TX (US)

(21) Appl. No.: 18/586,359

(22) Filed: Feb. 23, 2024

Related U.S. Application Data
(60) Provisional application No. 63/447,699, filed on Feb. 23, 2023.

(51) Int. Cl. G06F 16/383; G06F 16/35

(52) U.S. Cl. CPC G06F 16/383; G06F 16/35

(57) ABSTRACT

A method for estimating recall in database workflows involves assigning unique keys to documents in a database, generating a random permutation of the database, accessing coding decisions for documents, determining the longest prefix of the permutation with corresponding coding decisions, calculating the number of relevant documents, applying a confidence sequence generating algorithm to the prefix to establish a confidence interval on the relevant documents, and computing a confidence interval estimate on recall for the database. This method provides a systematic approach to assess recall in database workflows, enabling accurate evaluation of the retrieval performance of relevant documents within the database.

### CROSS-REFERENCE TO RELATED APPLICATIONS

This application claims the benefit of and priority to U.S. Provisional Patent Application No. 63/447,699, filed on Feb. 23, 2023, entitled Systems and Methods for Estimating the Effectiveness of Cumulative Coding of a Collection of Records, the contents of which are incorporated herein in the entirety.

### BACKGROUND

Technology-assisted review (TAR) is the use of computer technology, particularly supervised machine learning, to enhance manual document review workflows. The most prominent application of TAR is in the discovery process in civil litigation, where TAR is one tool in the larger endeavor of electronic discovery (eDiscovery). TAR has also been applied in systematic reviews of the scientific literature and other high recall retrieval tasks. There are two major types of TAR workflows. Two-phase workflows are focused on creation of a text classifier, whose predictions are then treated as definitive for some (though perhaps not all) purposes.

In another aspect, two-phase workflows are focused on creation of a text classifier identify a subset of documents to go to a second stage which may or may not double-check classifier decisions. Evaluation is focused on classifier quality. One-phase reviews by contrast are machine-supported manual reviews. Classifiers and other technologies may be used to bring documents to the attention of reviewers, but no document is treated as relevant without a manual decision that it is so. In another aspect, classifiers and other technologies may be used to bring documents to the attention of reviewers, the final relevance decision on any document is made by a person. Numerous proposals have emerged from the research community on how to evaluate and/or determine when to terminate a one phase TAR workflow. These proposals have seen little use in eDiscovery practice, which has relied on heuristics and semiformal uses of point estimates. The U.S. Department of Justice Antitrust Division's model agreement for use of supervised learning does not include the use of one-phase TAR workflows. We believe the lack of adoption of past proposals from the research community results from too little consideration of the difficulties faced by practitioners. Thus, there is a long sought need for a new evaluation approach for one-phase TAR.

### SUMMARY

In some aspects, the techniques described herein related to an evaluation method for estimating recall for database workflows, the method including: assigning a unique key to each document of a database for an evaluation, wherein the database includes a number of relevant documents and non-relevant documents; generating a random permutation of the database; accessing a set of coding decisions associated with one or more documents of the database; determining a longest prefix of the random permutation of the database for which corresponding documents have a coding decision; calculating a number of documents where the coding decision is defined as relevant; executing a confidence sequence generating algorithm on the longest prefix to yield a confidence interval on the number of relevant documents for the database; and calculating a confidence interval estimate on recall for the database.

In some aspects, the techniques described herein related to an evaluation method for estimating recall for database workflows, the method including: assigning a unique key to each document of a database for an evaluation; generating a random permutation of the database, wherein the database includes a number of relevant documents and non-relevant documents; estimating recall for the database at a first point in time; receiving notification of an insertion or deletion to the database at a second point in time; accessing a set of coding decisions associated with one or more documents of the database after the second point in time; determining, after the second point in time, a longest prefix of the random permutation of the database for which corresponding documents have a coding decision; calculating, after the second point in time, a number of documents where the coding decision is defined as relevant; executing a confidence sequence generating algorithm on the longest prefix to yield a confidence interval on the number of relevant documents for the database; and calculating an updated confidence interval estimate on recall for the database.

In some aspects, the techniques described herein related to an evaluation method for estimating recall for database workflows, the method including: providing an arbitrary seed that remains constant for the evaluation; producing, using the arbitrary seed, a unique permanent random number (PRN) associated with each document of the database, wherein the database includes a number of relevant documents and non-relevant documents; generating a random permutation of the database; accessing a set of coding decisions associated with one or more documents of the database; determining a longest prefix of the random permutation of the database for which corresponding documents have a coding decision; calculating a number of documents where the coding decision is defined as relevant; executing a Wauby-Smith and Ramdas algorithm on the longest prefix to yield a confidence interval on the number of relevant documents for the database; and calculating a confidence interval estimate on recall for the database.

In some aspects, the techniques described herein related to an evaluation method wherein assigning the unique key to each document of the database comprises providing an arbitrary seed that remains constant for the evaluation and that is used to generate the unique key.

In some aspects, the techniques described herein related to an evaluation method wherein assigning the unique key to each document of the database further comprises producing, using the arbitrary seed, a unique permanent random number (PRN) associated with each document of the database.

In some aspects, the techniques described herein related to an evaluation method wherein executing the confidence sequence generating algorithm comprises executing a Wauby-Smith and Ramdas algorithm.

In some aspects, the techniques described herein related to an evaluation method further comprising accessing a “working prior” value that remains constant during the evaluation.

In some aspects, the techniques described herein related to an evaluation method further comprising requesting a “working prior” value.

In some aspects, the techniques described herein related to an evaluation method wherein the method further comprises dropping from the yielded confidence intervals values that are inconsistent with the number of documents where the coding decision is defined as relevant.

In some aspects, the techniques described herein related to an evaluation method wherein calculating the confidence interval estimate on recall comprises calculating the confidence interval on recall at any point during the evaluation.

### DETAILED DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings:

FIG. 1 is an illustration of a flowchart of an example evaluation method for estimating recall for database workflows, according to the present disclosure.

FIG. 2 is an illustration of a flowchart of an example evaluation method for estimating recall for database workflows, according to the present disclosure.

FIG. 3 is an illustration of a flowchart of an example evaluation method for estimating recall for database workflows, according to the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises,” and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

### I. Keywords and Context

TAR workflows are central to electronic discovery (eDiscovery). Researchers have proposed many methods for evaluating TAR workflows, but this research has had little impact on eDiscovery practice. In one aspect, we disclose the operational constraints faced by eDiscovery reviewers and managers, and show how past evaluation proposals are inconsistent with their needs. In another aspect, we present a new evaluation approach for one-phase TAR workflows based on confidence sequences. The disclosure herein provides a review manager with complete control over the design and duration of the TAR workflow, as well as the amount and timing of review of evaluation documents. Evaluation documents can be reused for supervised learning while preserving valid frequentist confidence intervals on recall at all points during review. The method is expensive in terms of sample size but plausible for large scale reviews, and has many opportunities for improvement.

### II. One-phase TAR and its evaluation

We begin by reviewing a few key points on one-phase TAR evaluation and we then explore our contributions, e.g., a review of the demands facing both the individual reviewer and review manager in large-scale eDiscovery workflows, and how these force past evaluation techniques to be misused or underused; an evaluation method for one-phase TAR based on confidence sequences. It provides a review manager (a) complete control over the nature and duration of review, (b) complete control over the amount and timing of random sampling, (c) the ability to use random samples for both evaluation and training, and (d) valid frequentist confidence intervals on effectiveness at all points during the review and at its end; and an experimental study of the sample size requirements of our method.

Returning generally to one-phase TAR and its evaluation: in eDiscovery, one-phase workflows are often referred to using marketing terms, including TAR 2.0, Continuous Active Learning® 2, or CAL® 3. Evaluation in one-phase TAR or in TAR 2.0 has many aspects. In one aspect, TAR 2.0 comprises the use of random sampling to estimate recall (recall herein refers to the proportion of relevant documents that have been coded relevant during the one-phase review).

Recall estimates play two key roles. The first is certification: recall estimates may be used in defending a review to other parties and in courts of law. The second role is in process control: recall estimates are used by review managers in allocating resources, deploying technologies, predicting whether deadlines will be met, and deciding when to end a review. A recent overview of TAR in eDiscovery discusses the importance of both roles. From a statistical perspective, the dual roles present a challenge: using a sample-based estimate to decide when to stop a review process may bias that estimate and make it invalid for certification.

Evaluations of one-phase TAR reviews usually simply assume that manual coding decisions are correct, which we call the Perfect Review assumption. Review is, of course, not perfect. However, in a legal context, review is at some point finished (and signed off on by the responsible attorney). At that point, the only source of less-than-perfect effectiveness that can be formally acknowledged is the implicit negative prediction implied by failure of the review to code a document as either relevant or nonrelevant.

Past evaluation proposals have varied on whether relevant document found when coding random samples for evaluation should count toward effectiveness of the review. Since these documents must be produced in eDiscovery settings, we see no reason not to count them toward effectiveness.

### III. Reviewer factors

TAR is a human process. In this section we discuss three ways in which the subjective nature of review decisions interacts with the design of evaluation methods of the disclosure provided herein.

### 1. Coding Disagreements

A basic fact about review is that reviewers disagree. A failure to address this is a fundamental flaw with quantile estimation methods, e.g., the Target, QPET, and QBCB rules. These methods are based on measuring the ability of a review to re-find a hidden random sample of relevant documents. They provide both a limited degree of process control and a statistically valid estimate of recall for certification. Unfortunately, these methods assume that review decisions will never disagree with the gold standard coding of the hidden random sample, making them unusable in practice.

### 2. Cognitive Biases

Document review involves subjective human decisions which may be affected by a variety of cognitive biases. Automation Bias and Threshold Bias are two sources of bias that are likely to arise.

Briefly, Automation Bias refers to the tendency by people to rely on machine decisions as a heuristic replacement for vigilant information seeking and processing. Both omission errors (users failing to respond to irregularities because an automated system failed to detect or indicate them) and commission errors (where users incorrectly follow an automated recommendation) occur. Commission errors are the primary concern in TAR reviews, as most documents seen by reviewers will have been prioritized by the TAR system.

Threshold Bias refers to interpretation of borderline documents by reviewers is affected by whether they appear in the context of many vs. few other relevant documents. This means that reviewing a batch containing only a random sample of documents may lead to different decisions than if the random sample documents had been seen during normal review (when a larger fraction of relevant documents is present).

The challenge for evaluation is not that human review can be biased, but that those biases might operate differently during review of a random sample vs. the TAR-prioritized review. To complicate matters, there is evidence that sustained legal decision-making drains practitioners of cognitive energy, driving them to increasingly rely on heuristic rather than active analysis. This effect is consistent with the “cognitive miser” hypothesis of automation bias, where users prefer to rely on heuristics such as the machine heuristic, which assumes (among other things) that machines are more objective than humans. Taken together, this suggests that biases may even operate differently during the course of a day. Thus, there are several ways that coding decisions on a random sample could become unrepresentative of the population as a whole, and thus bias effectiveness estimates based on that random sample. This is a particular concern for the so-called “elusion-based” estimate of recall, which is one method used in one-phase TAR reviews for eDiscovery. This method is not actually based on elusion, but rather on estimating the number of uncoded relevant documents. While statistically valid for producing a single certification estimate after review is terminated on other grounds, the method is not valid for process control. We therefore refer to it as OneShot/URE (uncoded relevant estimation). While statistically valid for producing a single certification estimate after review is terminated on other grounds, the method is not valid for process control.

In one aspect, the method contemplates a concern that the count A is based on reviewer decisions made when reviewing TAR-prioritized documents rich in relevant documents, while the estimate of Z 0+ is based on review decisions for a sample of the documents TAR has depleted of relevant documents.

The two biases referenced earlier raise opposite concerns in this setting. If automation bias is operating during review, reviewers will be more apt to code borderline documents relevant when they know they have been prioritized by TAR than when they know they were randomly selected from a low-prevalence residue. If threshold bias is operating, then borderline documents are less likely to be coded relevant during review, and more likely to be coded relevant when seen during review of a low prevalence random sample. While we might hope the two biases cancel each other out, the reality is that they leave us simply unsure how to use the estimate.

One strategy for mitigating these biases is to mix the random sample documents with TAR-prioritized documents during review so that all documents are coded in the same context. However, this would require modifications both to methods that require coding a random sample before review begins (e.g., the quantile methods) and to methods based on coding a random sample of unreviewed documents (like OneShot/URE). Approaches based on estimating the total number of relevant documents in the collection more easily support such mixing.

### 3. Evolving Definition of Relevance

Continuing with the background that reviewers disagree referenced above. A failure to address this is a fundamental flaw with quantile estimation methods, e.g., the Target, QPET, and QBCB rules. Reviewers learn over time about the collected documents and the real world events they reflect, and their conception of which documents are relevant therefore evolves during the review. This is not “concept drift” in the machine learning sense, where the definition of category membership appropriate to an item may depend on the temporal context of the item. The intent in eDiscovery is that there is a single temporal context (the point at which the review is complete) and a uniform standard of relevance at that time. The concern is more mundane: how to achieve a uniform standard given that reviewers will learn over time.

To the extent that a uniform standard is not achieved, this may introduce bias in effectiveness estimates. If random sample documents are coded only at the beginning or only at the end of review, their coding may not be representative of coding in the review as a whole.

### IV. Management factors in Evaluations

Some studies of TAR algorithms and workflows for eDiscovery have used real-world data sets and considered complexities related to operational workflows. Studies of TAR evaluation methods and stopping rules, however, have not to our knowledge done this. This is natural, since the emphasis in these studies has been on estimation accuracy and ability to hit effectiveness targets. This means, however, that the evaluation literature has mostly not come to grips with the complexities of real world document reviews, and the demands they put on managers of those reviews.

Some studies of TAR algorithms and workflows for eDiscovery have used real-world data sets and considered complexities related to operational workflows. Studies of TAR evaluation methods and stopping rules, however, have emphasized statistical issues rather than operational issues. This has led to an under appreciation of the complexities review managers would face in using proposed evaluation approaches.

### 1. Example Review Goals and Termination

A document review can involve millions of documents, hundreds of human reviewers with varying availability and skills, high costs, extreme time pressures, and rapidly changing legal circumstances that may require review of particular sets of documents at particular times.

This immediately rules out interventional evaluation methods and stopping rules such as SCAL, Autostop—Conservative, and Autostop—Optimistic which force a particular form of active learning to be used. Some non-interventional methods are impractical for this reason as well.

The quantile methods avoid sequential bias by requiring that review proceed until a pre-defined estimated effectiveness target is met. In operational contexts, both the effectiveness target and the duration of the review may have to be changed at any point due to external factors.

More generally, evaluation methods which require restrictions on how review is carried out pose a double burden. They not only limit manager flexibility, but may raise questions among other parties in a legal matter about whether those restrictions were followed and thus whether claimed estimates are valid.

The optimal size of a random sample varies across TAR tasks. This presents difficulties for all evaluation methods based on a single fixed size sample. Further, review managers often want to increase sample size based on examining estimates from an initial sample. This biases the resulting estimates unless sequential methods are used.

### 2. Example Monitoring and Reporting

Certification requires only a single effectiveness estimate, produced after the review has ended. Review managers, however, need to monitor how estimated effectiveness is changing over time as a review proceeds.

Effectiveness cannot be monitored until an evaluation sample has been drawn, ruling out methods that sample only after review has ended, such as OneShot/URE. Leaving such methods aside, suppose we draw a random sample early in review, and use some valid method to compute a 95% confidence interval estimate on recall after each batch of documents is reviewed.

If a review manager is asked what recall was after 1000 documents were reviewed, they could report a 95% confidence interval on recall, and similarly if they are asked to do this after 1200 documents. What if the manager is asked to report what recall was after 1000 documents and what it was after 1200 documents? The manager cannot provide the intervals from the two points and validly claim to have 95% confidence. The reason is that the confidence level allows for 5% probability of error on a single estimate, and we now have two estimates in play. This is the problem of multiple comparisons bias.

Note that this problem is not addressed by stopping rules, since it concerns reporting before the review ends. There are general purpose methods, such as the Bonferroni correction, to adjust for multiple comparison bias. Unfortunately, because these methods make worst case assumptions, they would be greatly conservative (lead to lower confidence than necessary) in the above situation.

### 3. Example Batching, Aggregates, and Delay

Many research studies on TAR implicitly assume that a single document at a time is reviewed, with review of each document completed before the next is sent for review. While this workflow might occasionally be the case for a single reviewer (e.g., an investigator) using an interactive review interface, the review situation is usually far more complex.

For example, there are usually multiple reviewers, and thus multiple documents under review at any point in time. When there are multiple reviewers, documents are usually batched in groups of 10-200 documents and “checked out” for access by a single reviewer. There may be a substantial delay before the reviewed batch is checked back in, often because a reviewer may not check in a batch before the end of the work day.

Reviewers may “punt” on review decisions, checking back in an incompletely reviewed batch, or flagging some documents for follow-up by more experienced reviewers or supervisors. The choice to include one document in a batch may trigger the inclusion of other documents in that batch or in other batches. It is common in eDiscovery, for instance, to require that an email message and all its attachments be reviewed together. Related documents, such as email threads or near-duplicates, may also be batched together to speed review and improve coding consistency. (Exact duplicates are usually handled by reviewing only one copy and propagating coding to the others.)

This reality has several impacts on evaluation. First, Underdetermined Review Order. The order in which documents are reviewed is only loosely under control of the review manger, and is typically unknown within a review batch. Evaluation methods that require a single, clearly defined review order (the quantile methods again) will at a minimum require imposing an arbitrary order. Second, Delayed Coding of Evaluation Documents. The coding of random sample documents may be delayed, and we cannot assume the portion coded earliest is still a random sample. Reviewers may find it more difficult, for instance, to make a definitive assessment of a relevant document than of a nonrelevant one (or vice versa), delaying their coding. A review manager could prioritize review of evaluation documents (e.g., by more quickly reassigning delayed batches to new reviewers if they contain evaluation documents), but any differential treatment of evaluation documents risks bias. If only a small portion of the sample is unreviewed, it may still be possible to produce a useful confidence interval estimate. Most estimators require knowing only the size of the sample and the number of relevant documents found in it. Suppose we have a sample of size n, with n′<n of those documents having been reviewed, and n′+relevant documents among the n′ reviewed. Then the number of relevant documents in the fully reviewed sample is necessarily between n′+ and n−(n′−n′+). If we take the union of the confidence intervals produced for all values between n′+ and n−(n′−n′+), the result is a confidence interval that will have a desired confidence level regardless of how the sample is eventually completely labeled. (Most estimators actually have a monotonicity property that would actually require only the intervals based on the two values n′+ and n−(n′−n′+) to be computed.) Of course, unless n′ is very close to n, this process will lead to a uselessly wide confidence interval. Lastly, Limited Stopping Points. If review is done in batches, then only a limited set of potential stopping points (corresponding to batch boundaries) will typically be available. This does not pose validity issues for evaluation, but does mean that the total cost of a review will be somewhat higher than if instantaneous stopping was available.

### 4. Recycling Evaluation Documents

It is a core principle that training on evaluation data in supervised learning leads to overestimation of effectiveness. This is because the evaluation data is meant to be representative of as-yet-unseen future data to which we hope the classifier generalizes.

The situation is different in one-phase TAR. First, we are interested in evaluating the review itself, not learned classifiers that may have aided the review. Second, we are interested in review effectiveness on the current document collection. Generalization is not an issue: we can sample directly from the set of interest.

Recycling evaluation data for supervised learning is therefore problematic only if it makes the random sample unrepresentative of the document collection. While random data is less valuable than data selected by active learning, all training data is useful, and evaluation methods that allow this have been underexplored.

### 5. Information Hiding

Some TAR evaluation methods require hiding information from reviewers. Methods based on re-finding of gold labeled sample documents (the quantile methods) must hide both the identity and the coding of sample documents from reviewers. This would complicate reviewer management and user interface design.

A weaker form of information hiding is needed if it is desired that sample documents not be distinguishable when mixed with “normal” review documents (Section 3.2). This is easier, since reviewers typically receive documents in batches.

### 6. Quality Assurance

In one aspect we have described the review of a document as a single event. In practice, document reviews incorporate quality assurance (QA) checks with the dual goals of monitoring reviewer accuracy and improving the quality of the manual review decisions. These methods often involve targeted re-review of particular documents. While QA is critical to review quality, it has the potential of biasing evaluation. Performing QA only when estimated effectiveness is low, or stopping it only when effectiveness becomes high, obviously introduces bias. More subtly, coding random sample data differently than ordinary review data could make review decisions on the evaluation sample unrepresentative of review decisions in general. Unfortunately, avoiding differential review of random sample documents during QA is more difficult than avoiding it during the initial review. Batching by families and similar techniques (Section 4.3) introduces complex relationships between sampled and reviewed documents.

For example, performing QA only when estimated effectiveness is low, or stopping QA when effectiveness becomes high, would clearly introduce bias. More subtly, doing more QA on evaluation documents than on TAR-prioritized documents could make review decisions on the evaluation sample unrepresentative of review decisions in general.

To what extent these effects are a concern in practice is unclear. A perfect QA process would simply result in all reviewed documents being correctly coded, with no concern for bias. If this form of bias is a concern, the selection of documents for QA could be done using factors that are independent of the contents and coding of the random sample.

Leaving aside bias, integrating QA into a statistically valid evaluation process poses review management complexities. For instance, if a review was stopped based on hitting an estimated recall target, it is possible that target will no longer be met after QA of the coding decisions, and review will need to be restarted. Methods which have to draw an entirely new random sample on restart (e.g., OneShot/URE) are thus disfavored by the need for QA.

### 7. Summary

One primary aspect is that review managers need great flexibility in when and how to review documents, whether TAR-prioritized or random. Evaluation methods that constrain that flexibility will not be used.

### V. A New Framework for One-Phase Tar Evaluation

In response to these needs, we propose a novel evaluation approach. We present the five key components of the approach, show how they are combined in a single evaluation method, and review some practical details.

### 1. PRN-Based Collection Permutation

The method disclosed herein chooses, at the beginning of the TAR project, a random seed which stays constant through the project. Then it applies a cryptographic hash function to the concatenation of the seed and the unique ID of each document to produce a unique permanent random number (PRN) associated with that document. Collisions are resolved by adding another seed that extends all hash codes with less significant digits. Then the method sorts the (PRN, ID) pairs to define a random permutation of the collection.

The above method provides a method for maintaining a random permutation of a collection of records such that that permutation is drawn from a uniform distribution over all possible permutations of the collection. There are other strategies for accomplishing this as well. For instance, if documents do not have unique IDs, they may be given one by hashing their contents assuming that any two documents are distinguishable in some fashion. This hash code can play the role of the unique ID in producing a PRN for each document. Alternately, a unique document ID or hash code may be associated with a separately generated random number in a data structure, and this association maintained even if a document is removed (possibly temporarily) from the collection. This allows the uniform probability random permutation to be maintained throughout insertions into and deletions from the collection.

### 2. SRSWOR Sequence

In one aspect, estimates are based on simple random samples without replacement (SRSWORs), as in most TAR evaluation methods. Unlike conventional methods we use a nested sequence of SRSWORs corresponding to drawing one document at a time randomly from the collection. In particular, we use the random permutation to define a sequence of SRSWORs consisting of the first document of the permutation, the first two documents of the permutation, and so on, ending in a SRSWOR of size N which is simply the entire collection.

### 3. Denominator-Based Estimation of Recall

In one aspect, the method is based on evaluation on a confidence sequence associated with a sequential SRSWOR. A confidence sequence is a set of confidence intervals associated with the sequential drawing of a random sample. Just as a confidence interval is a structured estimate consisting of multiple point estimates, a confidence sequence is a structured estimate consisting of multiple confidence intervals.

First, estimate recall by first producing a frequentist 1 α confidence interval N\hat{ }+, N\hat{ }+on N+, the number of relevant documents in the collection. Under the Perfect Review assumption, the number of true positives (A) is known exactly, so A N\hat{ }+, A N\hat{ }+is a frequentist 1 α confidence interval on recall.

This approach, which is referenced as a denominator-based estimate of recall, has been criticized for producing logically impossible (e.g., greater than 1.0) values of recall. This is easily addressed, however, by truncating N\hat{ }+, N\hat{ }+ to be consistent with. Denominator-based estimates of recall have a key advantage: the population value estimated, N+, is a fixed property of the collection. This simplifies demonstrating validity of the method. The population value of recall changes throughout review, but only as the result of A changing, not N+. Estimated recall will also change during review, but only due to changes in the value of A and changes in the estimate of N+due to increases in sample size.

### 4. Example Confidence Sequences

In another aspect, the method is based on the evaluation on a confidence sequence associated with the sequential SRSWOR. A confidence sequence is a set of confidence intervals associated with the sequential drawing of a random sample. Just as a confidence interval is a structured estimate consisting of multiple point estimates, a confidence sequence is a structured estimate consisting of multiple confidence intervals.

For sequential SRSWOR from a finite population of size N, a confidence sequence consists of one confidence interval associated with the sample of size 1, one associated with the sample of size 2 (which contains the sample of size 1), and so on up to an interval associated with the unique sample of size N (the full population). A 1−α confidence sequence is produced by an estimator which guarantees there is at most a probability that any of those N confidence intervals omits the population value being estimated.

The interval at size N will collapse to the true population value. While not always part of the formal definition, we view the sequence as containing the interval [0, N] associated with the empty “sample” of size 0. This does not change the confidence level, and gives a total of N 1 intervals in the sequence.

Practical confidence sequence estimators allowing computing any of the component confidence intervals without computing the others. That is, if the estimator is given just the sample of size n, it can produce the confidence interval that holds for that sample. This is critical for practical use. Note that for our method, the sample of size n is the set of documents in the length n prefix of the collection permutation.

Just as different estimators can produce different confidence intervals for the same sample (e.g., one-sided vs. two-sided intervals), different confidence sequences can be produced from the same sequential SRSWOR. The shape of a confidence sequence refers to how the component intervals change during the growth of the sample, including how much they are skewed toward low or high values.

Confidence sequences were first developed in the late 1960s. Early approaches were limited in their applicability, but progress has accelerated in recent years. Major drivers have been the needs of reinforcement learning and the replication crisis in the sciences.

### 5. The WSR Estimator

In one aspect the method uses an estimator recently published by Waudby-Smith and Ramdas for producing a confidence sequence on N+ under sequential SRSWOR from a finite population, and refer to it as the WSR estimator. While proof of the estimator's correctness requires advanced notions from the theory of martingales, the algorithm itself is surprisingly simple.

Given the controversial status of Bayesian statistics in the law, it is important to stress, that this algorithm produces a frequentist inference, not a subjective Bayesian inference.

### 6. Putting the Pieces Together

In one aspect, the method combines these components in a one-phase TAR evaluation approach for estimating recall. The method applies the following quantities at any point during review:
N: The number of documents in the collection
Ht: The number of documents for which a coding decision has been received, with A=Ht+coded relevant, and Ht+ coded not relevant
nt: The number of coded documents in the longest fully coded prefix of the random collection permutation, with nt+ coded relevant and nt− coded nonrelevant

Here t is simply a point in time during the review project, not a particular number of documents.

### 7. Permutation and Revelation

Several aspects of the above framework may seem concerning. We do not treat “random documents” differently from “TAR documents”, nor do we care which documents were sent for review (or why), or whether review has ended (or why). We do not require the review manager to use the random permutation in selecting documents for review. Conversely, we do not forbid the review manager from examining the permutation and cherry-picking which documents to send for review, use for machine learning, or any other purpose. Finally, on a more technical point, review delays make it likely that the last document(s) in the fully coded prefix will disproportionately belong to the more quickly reviewed category.

To see that none of these factors introduce bias, it is helpful to focus on the full confidence sequence for sample sizes 0 to N. The Perfect Review assumption posits there is a correct category label for every document in the collection, and that review of a document simply reveals that label. If we were given those labels, plus the collection permutation, we could use the WSR estimator to generate all N+1 confidence intervals on N+. All N+1 intervals were completely determined the moment we generated the PRNs.

Review decisions therefore affect only which subset of the N+1 intervals whose values we know, not what those values are. Further, since the confidence level applies simultaneously to all N+1 intervals, it applies at least as strongly to any subset of intervals revealed by review. While the review manager could ignore the collection permutation in sending documents for review, they should not! Unless a substantial prefix is sent for review, confidence intervals will be uselessly wide. Similarly, our method does not change the fact that recall is expensive to estimate when prevalence is low.

Further, since the confidence level applies simultaneously to the entire set of N+1 intervals, the guarantee applies at least as strongly to any subset of those intervals. Review management decisions can only affect which documents are coded, and thus which intervals we can compute, but not what those intervals are or their should not! Unless a substantial fully coded prefix is available, confidence intervals will be uselessly wide (as we see in our experiments in Section 9).

Similarly, the method does not change the reality that recall is expensive to estimate when prevalence is low. In this circumstance, short fully coded prefixes have few relevant documents. This results in a confidence interval on N+that has a large ratio between the upper and lower values, and in turns gives a wide confidence interval on recall (see Section 9).

### 8. Mitigating Delayed Coding

The method provides modest robustness against delayed coding of randomly prioritized documents, in that the fully coded prefix (whatever it is) is always valid. Further, if only a few such documents are delayed, we can apply the mitigation strategy.

The method provides modest robustness against delayed coding of randomly selected documents, in that the fully coded prefix (whatever it is) is always valid. However, if the first n documents in the permutation have been sent for review, and m of these have not yet received coding, the average length of the fully coded prefix is only n/m documents.

If m is small, we can apply the mitigation strategy previously discussed. Each component interval produced by the WSR estimator is based only on the size of a SRSWOR and the number of relevant documents found in it. We can compute the smallest and largest values for the number of relevant documents that sample could have, compute the two WSR intervals, and take the range they span as a valid interval without changing the confidence level. This process can be repeated for all prefixes from size 0 to the size N, and the simultaneous guarantee means we are free to choose the best of these intervals.

### 9. Efficiency

In many aspects the WSR algorithm is efficient. For example, in one example, an unoptimized Python implementation is able to compute a single component interval in about 10 seconds. Computation of PRNs takes less than 200 milliseconds for a 160K dataset.

### 10. Collection Changes

Like any TAR evaluation method, the confidence sequence method must deal with three challenges posed by collection changes: updating random samples, minimizing the cost impact of changes, and avoiding multiple comparisons bias. The use of PRNs is helpful here. Rather than having to update the dynamic state of a sampling routine, we simply compute PRNs for new documents (extending the hash to avoid duplicates if necessary), discard PRNs for deleted documents, and sort the updated collection by PRN.

On the cost front, documents that had small PRNs in the old collection still have small PRNs in the new collection. This maximizes overlap between the fully coded prefixes across collection changes, just as PRNs maximize overlap in longitudinal survey research on changing populations. Costs can be minimized by avoiding review of a large prefix if it is likely the collection will substantially change in size in the future.

Risks of statistical bias with respect to collection changes are largely the same for our method as for usual TAR evaluation methods. Using confidence sequence estimates to decide how to alter a collection (e.g., by removing a custodian for which estimated recall is low) would bias those estimates. Our confidence level does not apply simultaneously to assertions made across different versions of a collection, even if such changes are independent of evaluation.

Risks of statistical bias with respect to collection changes are similar to existing TAR evaluation methods. Using confidence sequence estimates to decide how to alter a collection (e.g., by removing a custodian for which estimated recall is low) would bias estimates and should not be done. In addition, our confidence level does not apply simultaneously to assertions made across different versions of a collection, even if such changes were independent of consulting estimates.

### VI. Monitoring and Reporting

Managers need to monitor the progress of recall over time. The method contemplates two goals of monitoring below.

### 1. Recording Historical Estimates

Documentation of recall estimates over time may be needed to defend process decisions. A review platform could be configured to estimate effectiveness periodically based on the current state of review, including the fully coded prefix at that point in time.

### 2. Understanding Review Progress

If the goal is understanding how review is progressing, however, a historical record of past estimates is not optimal. Such a record conflates actual increases in recall with improvements in estimation of recall. We can do better by distinguishing between two roles that documents early in the permutation play. For example, documents selected for review because of their early position in the permutation are part of the review progress at that time regardless of whether they are part of the fully coded prefix at that time. At the time a manager asks for a graph of past review progress, some fully coded prefix will be available. That fully coded prefix can and should be used to estimate what effectiveness was at all past states of the review, even at points in time before that prefix was available.

Concretely, assume at time t we wish to graph the past progress of the review. We compute a confidence interval on N+using the longest fully coded prefix at time t. Then for each time point s earlier in review, we use that time-t confidence interval on N+in computing an interval on recall, given the state of review at that point s.

### VII. Benefits

The confidence sequence method addresses many of the challenges we identified in previous sections.

Coding Disagreements. We assume a single review standard. No possibility of conflict with a separate gold standard exists.

Cognitive Biases and Evolving Definition of Relevance. We allow the review manager complete flexibility in specifying the timing and context of review of random sample documents, which aids them in managing these issues.

Review Goal and Termination. We allow the review manager complete flexibility to change recall targets and start and stop the review.

Monitoring and Reporting. Our method provides estimates of recall at any and all points during the review, with the confidence level applying simultaneously to all estimates.

Batching, Aggregates, and Delay. Our method cares only which documents were reviewed, not how they were grouped or ordered. It, like any evaluation method, is affected by delayed coding of evaluation documents, but its sequential approach provides some minor robustness.

Recycling Evaluation Documents. Evaluation documents can freely be used for supervised learning with no impact on validity of estimates.

Information Hiding. Our method does not rely on refinding of hidden documents. Whether to hide the fact that certain documents were prioritized due to appearing early in the random permutation is up to the review manager.

Quality Assurance. Our method avoids the need to draw a new random sample if review is restarted after QA, which is an advantage over methods such as OneShot/URE. However, it would face the same statistical bias problems as other methods if QA decisions were made based on effectiveness estimates.

Surprisingly, most of these advantages accrue to any evaluation method using a denominator-based estimate of recall, including the long-known and underappreciated countdown method. That method requires choosing a sample size, drawing a SRSWOR of that size at the start of review, estimating a single conventional confidence interval on N+from that SRSWOR, and deriving all confidence intervals on recall from that single interval on N+.

What the simpler method lacks, however, is the ability to tune sample size to a review task while maintaining the validity of estimates. In addition, an early commitment to sample size limits flexibility in dealing with collection changes, and makes mixing random sample and TAR-prioritized documents more awkward.

### VIII. Experiment

The advantages of confidence sequences are remarkable. To see what price must be paid for them, we empirically compared sample size efficiency for our method with that of OneShot/URE. OneShot/URE can be used with any confidence interval esti-mator for Z°+(the number of unreviewed documents). We follow the typical approach in eDiscovery, which is to estimate a 95% exact binomial confidence interval on the proportion ρ° of relevant documents among the unreviewed documents. We produce both two-sided and upper one-sided intervals on the proportion, multi-ply by Z° (number of unreviwed documents) to get two-sided and upper one-sided intervals on Z°+, and then transform to two-sided and lower one-sided intervals on recall as in Section 3.2. For the confidence sequence method we produce 95% exact confidence sequences on N+ and convert them to confidence sequences on recall. For comparison with two-sided OneShot/URE intervals we use a beta-binomial working prior on N+with α=1, β=1. This prior assigns a prior probability of 1 N 1 to each value between 0 and N. The WSR method does not provide a way to force one-sided intervals, so for comparison with OneShot/URE lower one-sided intervals we use a working prior skewed toward low values of N+(α=1 99, β=1).

In one aspect, the method comprises estimators in a simulation that allows holding other factors constant. We use 9 runs, in the form of pickled Python data structures. The runs consist of simulated one-phase TAR workflows for 9 categories on a 20% subset (160822 documents) of the Reuters RCV1-v2 collection. A seed document for each category was used to initialize training for that category, and then up to 780 rounds of relevance feedback (i.e., training on top-ranked documents from the previous round's model) were executed with batches of size 200 until a recall of 0.80 for that category was reached.

We sorted the batch on which 0.80 recall was reached by the document scores for the model used to generate that batch. We then found the exact document in that ordered batch on which 0.80 for that category was first reached. We defined the review-coded documents for the category to be those documents in that final batch up through and including the document on which 0.80 was reached, along with all documents from earlier batches, and the seed document. All other documents were considered to belong to the unreviewed portion of the collection. Random samples for both methods were produced using the same PRN-based random permutation.

The SRSWOR for OneShot/URE is defined to be the earliest G documents (in permutation order) in the unreviewed portion of the collection. For the confidence sequence method, we use the longest prefix of the permutation such that it contains exactly those G uncoded documents (in addition to any coded documents). The size of the prefix is therefore somewhat larger than G, but corresponding the same additional coding effort as OneShot/URE (G documents).

### IX. Sample Results

Intervals from the confidence sequence method are much wider than for OneShot/URE. The sample size necessary to exclude a particular value of recall from an interval is 4 to 16 times larger with the confidence sequence method than with OneShot/URE. FIG. 2 compares one-sided OneShot/URE intervals vs. confidence sequence intervals using the skewed working prior, and shows the same pattern but with slightly faster decrease of recall on the low end. Even with the flat working prior, the nominally two-sided confidence sequence intervals almost always have an upper bound on recall equal to 1.0. This is a characteristic of denominator-based confidence intervals on recall, not of confidence sequences in particular. If the recall of the review is r, that means we have seen Z+=r N+relevant documents. Removing logically impossible values from the interval on N+makes r N+the lower bound for the adjusted interval unless the estimated interval already had a lower bound greater than r N+. The logical lower limit on N+also increases as relevant documents are found in the random sample. For our low categories, the upper limit on recall usually ends up being the logical limit 1.0.

### 1. Implications

In one aspect, the large sample sizes required by the confidence sequence method may seem discouraging, so it is important to stress that our setting was a particularly harsh test. The prevalences we used were low by eDiscovery standards, and indeed most are below the point at which one would attempt an estimate of recall. The collection size was also relatively small. Past a few tens of thousands of documents, collection size does not meaningfully increase sample size. Our sample sizes would be palatable in large legal matters, which can involve reviewing hundreds of thousands of documents prioritized from millions of collected documents.

The increased sample size required by the confidence sequence method at first seems discouraging, so it is important to stress that our setting was a particularly harsh test. First, the prevalence we used were low by eDiscovery standards, and indeed most are below the point at which one would attempt an estimate of recall. The collection size was also relatively small. Sample sizes barely grow with increased collection size, and the values we see would be palatable for collections in the millions of documents.

Further, by forcing the confidence sequence method to be used in the same fashion as OneShot/URE (producing a single confidence interval after review has been ended), we substantially handicapped it in our comparison. We did not take advantage of the ability to allocate review effort between TAR-prioritized documents and random documents to minimize total coding budget for a particular recall goal. Nor did we take advantage of the fact that random sample data can be recycled for supervised learning, improving the predictive model. We also did not take advantage of the fact that using a working prior based on a good guess of N+will narrow intervals.

Our simulation also hid OneShot/URE's weaknesses. Parties in eDiscovery will often agree on a maximum confidence interval width as well as a recall target. To meet such a guarantee while avoiding sequential bias OneShot/URE would need to do one or more of the following, all of which incur additional review costs: Use an additional random sample to decide when to stop review, Overshoot recall substantially, and/or use a large sample to compensate for not knowing how close the recall's review is to a target value.

Reviewer bias is an issue with OneShot/URE, as previously mentioned. Finally, OneShot/URE really does get only one shot. If sampling shows it missed its goal, there is no statistically valid recovery mechanism available. The confidence sequence method never fails: a statistically valid result meeting a target recall goal can always be achieved with enough review.

Reviewer bias is also harder to manage with OneShot/URE. Finally, OneShot/URE really does get only one shot. If sampling shows a recall target was missed, there is no statistically valid recovery mechanism available. The confidence sequence method never fails: a statistically valid result meeting a target recall goal can always be achieved with enough review.

Looking forward, additional theoretical work may lead to better confidence sequence estimators, achieving simultaneous confidence guarantees across multiple versions of a collection, and extending the method to two-phase TAR.

### X. Advancements

As discussed above, the flexibility our method offers opens up many opportunities for improvement. Additional areas for theoretical work include better confidence sequence estimators, achieving simultaneous confidence guarantees across multiple versions of a collection, and extending the method to two-phase TAR.

### XI. Summary

In one aspect, disclosed is a new approach to one-phase TAR evaluation which maximizes the flexibility given to a review manager while maintaining statistical validity of recall estimates at every point during the review. Our confidence sequence method currently has a large cost in increased sample size, but has great room for improvement, and would already be affordable for large reviews. This is particularly true since high quality estimates of recall throughout a review will aid resource allocation and review planning, and avoid the cost and legal risk of failed validations.

In another aspect, disclosed is a new approach to one-phase TAR evaluation which maximizes the flexibility given to a review manager while maintaining statistical validity of recall estimates at all points during review. Our confidence sequence method is expensive in terms of sample size, but would be affordable for large reviews and has many avenues for improvement. High quality estimates of recall throughout a review will also aid resource allocation and review planning, and avoid the cost and legal risk of failed validations, and so may repay themselves many times over.

### XII. Machine Learning for Electronic Discovery in Legal Cases

The visual presentation of a multi-stage review process, however, emphasizes removal of documents by various steps, rather than coding of documents by various steps. The two are equivalent in the sense that the removal of a document by a stage of a process is a type of definitive negative coding of that document.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### XIII. With Reference to the Figures

Turning now to the figures, FIG. 1 is an illustration of a flowchart of an example evaluation method for estimating recall for database workflows, according to the present disclosure. In particular, an evaluation method 100 for estimating recall for database workflows, includes: assigning a unique key to each document of a database for an evaluation, wherein the database includes a number of relevant documents and non-relevant documents (101); generating a random permutation of the database; (103) accessing a set of coding decisions associated with one or more documents of the database (105); determining a longest prefix of the random permutation of the database for which corresponding documents have a coding decision (107); calculating a number of documents where the coding decision is defined as relevant; (109) executing a confidence sequence generating algorithm on the longest prefix to yield a confidence interval on the number of relevant documents for the database (111); and calculating a confidence interval estimate on recall for the database (113).

FIG. 2 is an illustration of a flowchart of an example evaluation method for estimating recall for database workflows, according to the present disclosure. In particular, an evaluation method 200 for estimating recall for database workflows, includes: assigning a unique key to each document of a database for an evaluation (201); generating a random permutation of the database, wherein the database includes a number of relevant documents and non-relevant documents (203); estimating recall for the database at a first point in time (205); receiving notification of an insertion or deletion to the database at a second point in time (207); accessing a set of coding decisions associated with one or more documents of the database after the second point in time (209); determining, after the second point in time, a longest prefix of the random permutation of the database for which corresponding documents have a coding decision (211); calculating, after the second point in time, a number of documents where the coding decision is defined as relevant (213); executing a confidence sequence generating algorithm on the longest prefix to yield a confidence interval on the number of relevant documents for the database (215); and calculating an updated confidence interval estimate on recall for the database (217).

FIG. 2 is an illustration of a flowchart of an example evaluation method for estimating recall for database workflows, according to the present disclosure. In particular, an evaluation method 300 for estimating recall for database workflows, includes: providing an arbitrary seed that remains constant for the evaluation (301); producing, using the arbitrary seed, a unique permanent random number (PRN) associated with each document of the database, wherein the database includes a number of relevant documents and non-relevant documents (303); generating a random permutation of the database (305); accessing a set of coding decisions associated with one or more documents of the database (307); determining a longest prefix of the random permutation of the database for which corresponding documents have a coding decision (309); calculating a number of documents where the coding decision is defined as relevant (311); executing a Wauby-Smith and Ramdas algorithm on the longest prefix to yield a confidence interval on the number of relevant documents for the database (313); and calculating a confidence interval estimate on recall for the database (315).

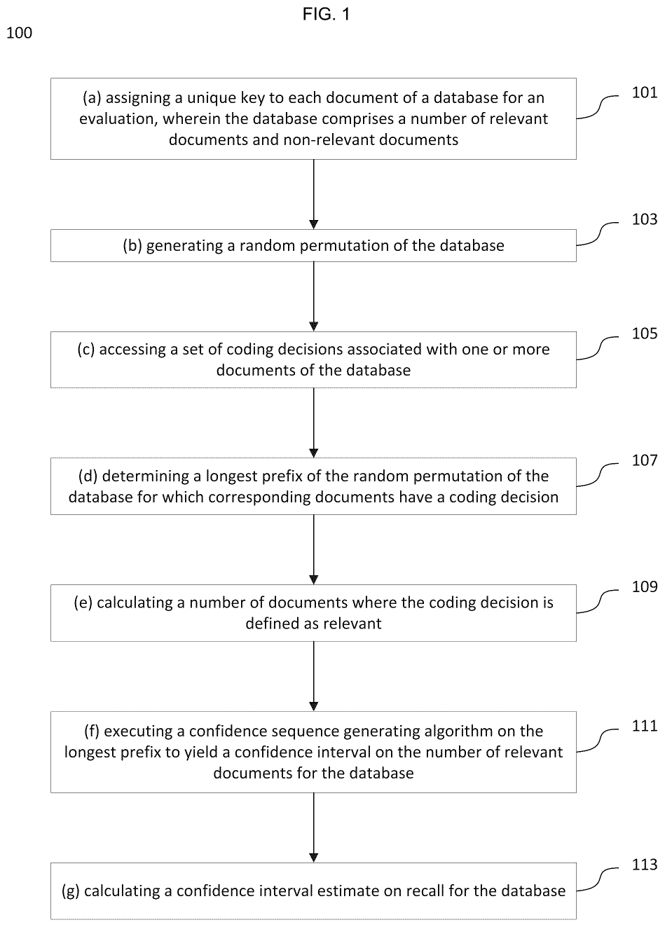

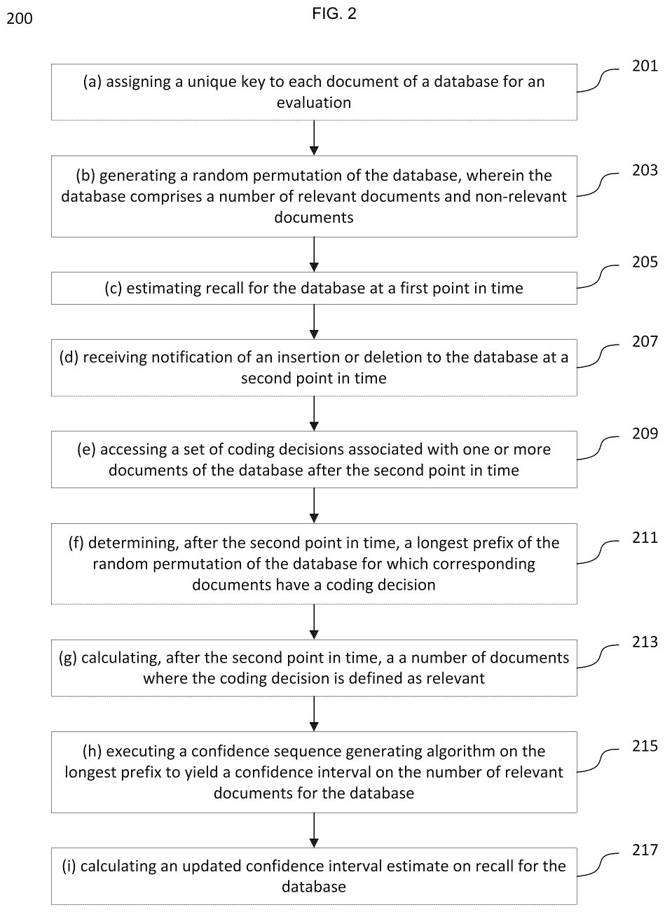

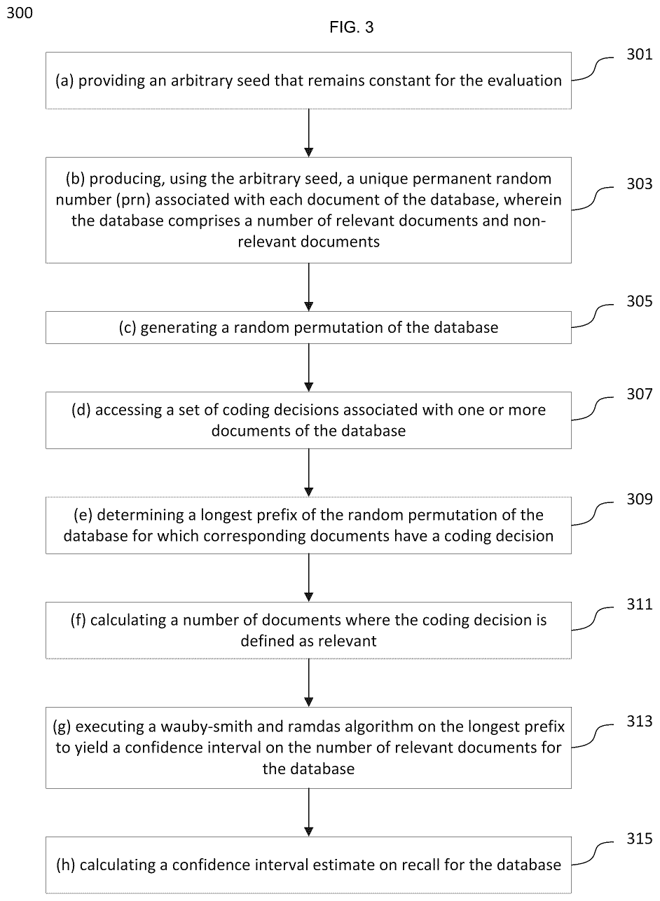

Therefore, the following is claimed:

1. An evaluation method for estimating recall for database workflows, the method comprising:
a. assigning a unique key to each document of a database for an evaluation, wherein the database comprises a number of relevant documents and non-relevant documents;
b. generating a random permutation of the database;
c. accessing a set of coding decisions associated with one or more documents of the database;
d. determining a longest prefix of the random permutation of the database for which corresponding documents have a coding decision;
e. calculating a number of documents where the coding decision is defined as relevant;
f. executing a confidence sequence generating algorithm on the longest prefix to yield a confidence interval on the number of relevant documents for the database; and
g. calculating a confidence interval estimate on recall for the database.

2. The method of claim 1, wherein assigning the unique key to each document of the database comprises providing an arbitrary seed that remains constant for the evaluation and that is used to generate the unique key.

3. The method of claim 2, wherein assigning the unique key to each document of the database further comprises producing, using the arbitrary seed, a unique permanent random number (PRN) associated with each document of the database.

4. The method of claim 1, wherein executing the confidence sequence generating algorithm comprises executing a Wauby-Smith and Ramdas algorithm.

5. The method of claim 1, further comprising accessing a “working prior” value that remains constant during the evaluation.

6. The method of claim 1, further comprising requesting a “working prior” value.

7. The method of claim 1, wherein the method further comprises dropping from the yielded confidence intervals values that are inconsistent with the number of documents where the coding decision is defined as relevant.

8. The method of claim 1, wherein calculating the confidence interval estimate on recall comprises calculating the confidence interval on recall at any point during the evaluation.

9. An evaluation method for estimating recall for database workflows, the method comprising:
a. assigning a unique key to each document of a database for an evaluation;
b. generating a random permutation of the database, wherein the database comprises a number of relevant documents and non-relevant documents;
c. estimating recall for the database at a first point in time;
d. receiving notification of an insertion or deletion to the database at a second point in time;
e. accessing a set of coding decisions associated with one or more documents of the database after the second point in time;
f. determining, after the second point in time, a longest prefix of the random permutation of the database for which corresponding documents have a coding decision;
g. calculating, after the second point in time, a a number of documents where the coding decision is defined as relevant;
h. executing a confidence sequence generating algorithm on the longest prefix to yield a confidence interval on the number of relevant documents for the database; and
i. calculating an updated confidence interval estimate on recall for the database.

10. The method of claim 9, wherein assigning the unique key to each document of the database comprises providing an arbitrary seed that remains constant for the evaluation and that is used to generate the unique key.

11. The method of claim 10, wherein assigning the unique key to each document of the database further comprises producing, using the arbitrary seed, a unique permanent random number (PRN) associated with each document of the database.

12. The method of claim 9, wherein executing the confidence sequence generating algorithm comprises executing a Wauby-Smith and Ramdas algorithm.

13. The method of claim 9, further comprising accessing a “working prior” value that remains constant during the evaluation.

14. The method of claim 9, further comprising requesting a “working prior” value.

15. The method of claim 9, wherein the method further comprises dropping from the yielded confidence intervals values that are inconsistent with the number of documents where the coding decision is defined as relevant.

16. An evaluation method for estimating recall for database workflows, the method comprising:
a. providing an arbitrary seed that remains constant for the evaluation;
b. producing, using the arbitrary seed, a unique permanent random number (PRN) associated with each document of the database, wherein the database comprises a number of relevant documents and non-relevant documents;
c. generating a random permutation of the database;
d. accessing a set of coding decisions associated with one or more documents of the database;
e. determining a longest prefix of the random permutation of the database for which corresponding documents have a coding decision;
f. calculating a number of documents where the coding decision is defined as relevant;
g. executing a Wauby-Smith and Ramdas algorithm on the longest prefix to yield a confidence interval on the number of relevant documents for the database; and
h. calculating a confidence interval estimate on recall for the database.

17. The method of claim 16, further comprising accessing a “working prior” value that remains constant during the evaluation.

18. The method of claim 16, further comprising requesting a “working prior” value.

19. The method of claim 16, wherein the method further comprises dropping from the yielded confidence intervals values that are inconsistent with the number of documents where the coding decision is defined as relevant.

20. The method of claim 16, wherein calculating the confidence interval estimate on recall comprises calculating the confidence interval on recall at any point during the evaluation.
